(19) United States
(12) Patent Application Publication
(10) Pub. No.: US 2025/0222656 A1
(43) Pub. Date: Jul. 10, 2025

(54) DETERMINATION OF EXTRUSION COMPONENT HEALTH IN 3D PRINTING

(71) Applicant: Markforged, Inc., Waltham, MA (US)

(72) Inventors: Jeremy Kanovsky, Cambridge, MA (US); Harrison Davis, Waltham, MA (US); Nicholas Kalweit, Cambridge, MA (US); Bruce David Jones, Sudbury, MA (US)

(21) Appl. No.: 19/010,622

(22) Filed: Jan. 6, 2025

Related U.S. Application Data
(60) Provisional application No. 63/618,078, filed on Jan. 5, 2024.

(51) Int. Cl. B29C 64/393; B29C 64/118; B33Y 10/00; B33Y 30/00; B33Y 50/02

(52) U.S. Cl. CPC B29C 64/393; B29C 64/118; B33Y 10/00; B33Y 30/00; B33Y 50/02

(57) ABSTRACT

A 3D printing apparatus and method determines a health of an extrusion sub-system. The extrusion sub-system is controlled to perform a controlled extrusion of 3D print material, during which sensor data is collected. The controlled extrusion may include a sweep across multiple extrusion speeds, and the collected sensor data may include a measured extrusion force. The collected sensor data is analyzed to determine the presence of any abnormalities indicating a potential issue with the extrusion sub-system.

### CROSS-REFERENCE TO RELATED APPLICATION

This application claims the benefit under 35 U.S.C. § 119(e) of U.S. Provisional Patent Application No. 63/618,078, filed Jan. 5, 2024, and titled “DETERMINATION OF EXTRUSION COMPONENT HEALTH IN 3D PRINTING,” the entirety of which is incorporated herein by reference.

### FIELD OF THE INVENTION

The invention relates to an apparatus and method for 3D printing that determines the health of an extrusion sub-system of a 3D printing apparatus.

### BRIEF DESCRIPTION OF THE DRAWINGS

FIGS. 1A and 1B illustrate an apparatus, in accordance with one embodiment.

FIG. 2 is a flow chart for an operation for determining the health of an extrusion sub-system of the apparatus, in accordance with one embodiment.

FIG. 3 illustrates an example of received telemetry data, in accordance with one embodiment.

FIG. 4 illustrates an example of discontinuities in received telemetry data, in accordance with one embodiment.

FIG. 5 illustrates an example of discontinuities in received telemetry data, in accordance with one embodiment.

### DETAILED DESCRIPTION OF THE PREFERRED EMBODIMENTS

The present invention relates to an apparatus and method of determining the health of an extrusion sub-system of the apparatus.

### 3D Printer Apparatus

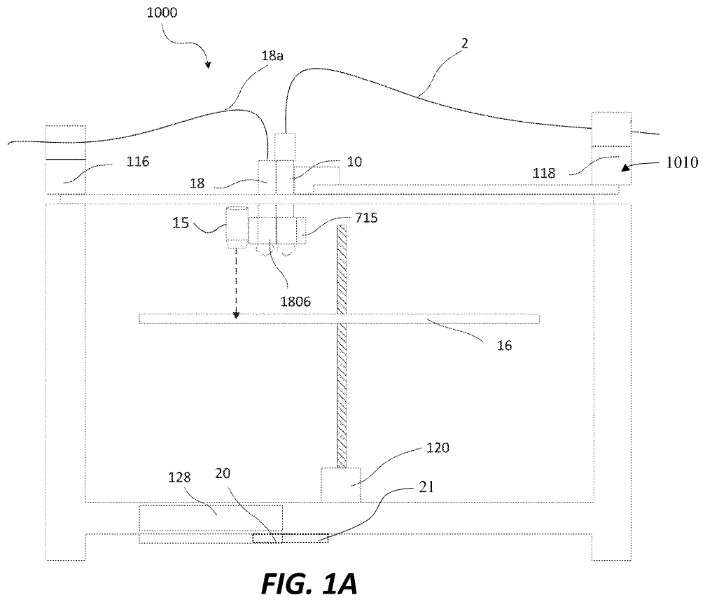

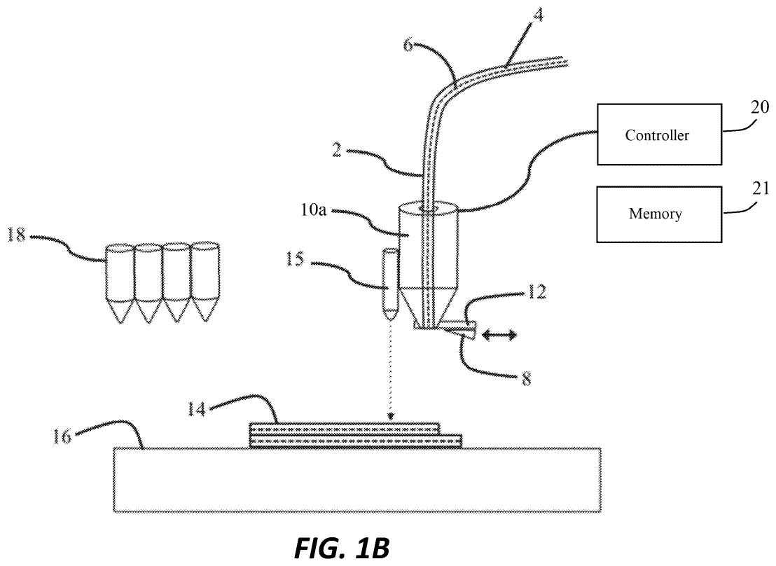

FIGS. 1A-1B illustrate an apparatus 1000 in accordance with one embodiment of the invention. The apparatus 1000 includes one or more controllers 20, one or more memories 21, and one or more print heads 10, 18. For instance, one head 10 may deposit a metal or fiber reinforced composite filament 2, and another head 18 may apply pure or neat matrix resin 18a (thermoplastic or curing), which may include, but is not limited to, a polymer or curable monomer and/or a polymer or curable monomer filled, e.g., with chopped carbon fiber, carbon black, silica, and/or aramid fiber. In the case of the filament 2 being a fiber reinforced composite filament, such filament (also referred to herein as continuous core reinforced filament) may be substantially void free and include a polymer or resin that coats, permeates or impregnates an internal continuous core (including, but not limited to, single, multi-strand, or multi-material). It should be noted that although the print head 18 is shown as an extrusion print head, “fill material print head” 18 as used herein includes optical or UV curing, heat fusion or sintering, or “polyjet”, liquid, colloid, suspension or powder jetting devices (not shown) for depositing fill material. It will also be appreciated that a material bead formed by the filament 2 may be deposited as extruded thermoplastic or metal, deposited as continuous or semi-continuous fiber, solidified as photo or UV cured resin, or jetted as metal or binders mixed with plastics or metal, or are structural, functional or coatings. The fiber reinforced composite filament 2 (also referred to herein as continuous core reinforced filament) may be a push-pulpreg that is substantially void free and includes a polymer or resin 4 that coats or impregnates an internal continuous single core or multistrand core 6. The apparatus includes heaters 715, 1806 to heat the print heads 10, 18, respectively so as to facilitate deposition of layers of material to form the object 14 to be printed. A cutter 8 controlled by the controller 20 may cut the filament 2 during the deposition process in order to (i) form separate features and components on the structure as well as (ii) control the directionality or anisotropy of the deposited material and/or bonded ranks in multiple sections and layers. As depicted, the cutter 8 is a cutting blade associated with a backing plate 12 located at the nozzle outlet. Other cutters include laser, high-pressure air or fluid, or shears. The apparatus 1000 may also include additional non-printing tool heads, such as for milling, SLS, etc. The apparatus 1000 may also include a touch screen display panel 128 to provide user feedback and accept inputs, commands, and control parameters from the user.

The apparatus 1000 includes a gantry 1010 that supports the print heads 10, 18. The gantry 1010 includes motors 116, 118 to move the print heads 10, 18 along X and Y rails in the X and Y directions, respectively. The apparatus 1000 also includes a build platen 16 (e.g., print bed) on which an object to be printed is formed. The height of the build platen 16 is controlled by a motor 120 for Z direction adjustment. Although the movement of the apparatus has been described based on a Cartesian arrangement for relatively moving the print heads in three orthogonal translation directions, other arrangements are considered within the scope of, and expressly described by, a drive system or drive or motorized drive that may relatively move a print head and a build plate supporting a 3D printed object in at least three degrees of freedom (i.e., in four or more degrees of freedom as well). For example, for three degrees of freedom, a delta, parallel robot structure may use three parallelogram arms connected to universal joints at the base, optionally to maintain an orientation of the print head (e.g., three motorized degrees of freedom among the print head and build plate) or to change the orientation of the print head (e.g., four or higher degrees of freedom among the print head and build plate). As another example, the print head may be mounted on a robotic arm having three, four, five, six, or higher degrees of freedom; and/or the build platform may rotate, translate in three dimensions, or be spun.

FIG. 1B depicts an embodiment of the apparatus 1000 applying the filament 2 to build a structure. In one embodiment, the filament 2 is a metal filament for printing a metal object. In one embodiment, the filament 2 is a fiber reinforced composite filament (also referred to herein as continuous core reinforced filament) may be a push-pulpreg that is substantially void free and includes a polymer or resin 4 that coats or impregnates an internal continuous single core or multistrand core 6. In one embodiment, the filament 2 is an unreinforced filament.

The filament 2 is fed through a nozzle 10a disposed at the end of the print head 10, and heated to extrude the filament material for printing. In the case that the filament 2 is a fiber reinforced composite filament, the filament 2 is heated to a controlled push-pultrusion temperature selected for the matrix material to maintain a predetermined viscosity, and/or a predetermined amount force of adhesion of bonded ranks, and/or a surface finish. The push-pultrusion may be greater than the melting temperature of the polymer 4, less than a decomposition temperature of the polymer 4 and less than either the melting or decomposition temperature of the core 6.

After being heated in the nozzle 10a and having its material substantially melted, the filament 2 is applied onto the build platen 16 to build successive layers 14 to form a three dimensional structure. One or both of (i) the position and orientation of the build platen 16 or (ii) the position and orientation of the nozzle 10a are controlled by a controller 20 to deposit the filament 2 in the desired location and direction. Position and orientation control mechanisms include gantry systems, robotic arms, and/or H frames, any of these equipped with position and/or displacement sensors to the controller 20 to monitor the relative position or velocity of nozzle 10a relative to the build platen 16 and/or the layers 14 of the object being constructed. The controller 20 may use sensed X, Y, and/or Z positions and/or displacement or velocity vectors to control subsequent movements of the nozzle 10a or platen 16. The apparatus 1000 may optionally include a laser scanner 15 to measure distance to the platen 16 or the layer 14, displacement transducers in any of three translation and/or three rotation axes, distance integrators, and/or accelerometers detecting a position or movement of the nozzle 10a to the build platen 16. The laser scanner 15 may scan the section ahead of the nozzle 10a in order to correct the Z height of the nozzle 10a, or the fill volume required, to match a desired deposition profile. This measurement may also be used to fill in voids detected in the object. The laser scanner 15 may also measure the object after the filament is applied to confirm the depth and position of the deposited bonded ranks. Distance from a lip of the deposition head to the previous layer or build platen, or the height of a bonded rank may be confirmed using an appropriate sensor.

Various 3D-printing aspects of the apparatus 1000 are described in detail in U.S. Patent Application Publication No. 2019/0009472, which is incorporated by reference herein in its entirety.

### Operation for Determines the Health of an Extrusion Sub-System of the 3D Printing Apparatus

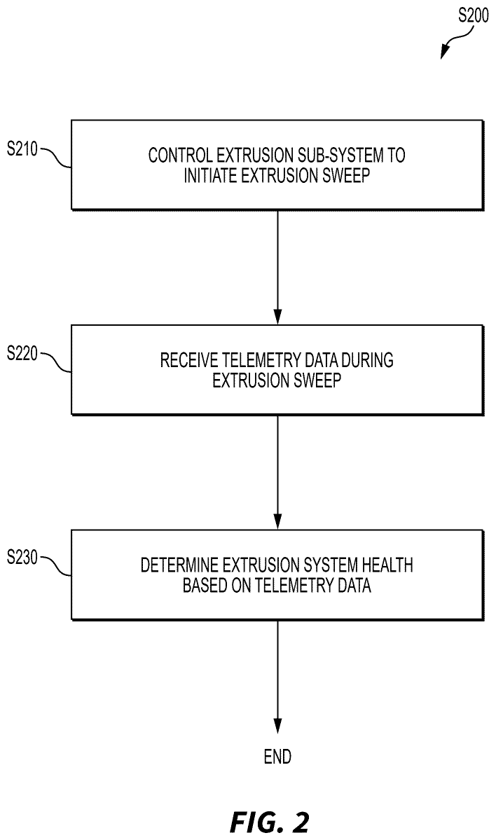

FIG. 2 illustrates an operation S200 for determining the health of an extrusion sub-system of the 3D printing apparatus. The extrusion sub-system, as referenced herein, may include the various components of the apparatus 1000 to extrude 3D print material, including at least the motors 116, 118 and the print head 10 and/or print head 18. The determined extrusion sub-system health may in turn be used to determine whether components of the apparatus 1000 may be worn or otherwise malfunctioning, and may provide indication to an operator as to whether the apparatus 1000 is in need of repairs and that printing operations should be suspended in the interim.

In one aspect of the invention, operation S200 is performed prior to printing a 3D part. In one aspect of the invention, operation S200 is performed as part of other printer utilities. In one aspect of the invention, operation S200 is performed during printing of a 3D part.

In step S210, the controller 20 controls the extrusion sub-system to initiate an extrusion sweep. In one embodiment, an extrusion sweep involves controlling the extrusion sub-system to extrude print material according to a predetermined sequence. In one embodiment, an extrusion sweep involves extrusion at multiple extrusion speeds. In one embodiment, the extrusion speed sweeping is incremental such that the extrusion speed increases (or decreases) in a step-wise manner such that material is extruded at predefined extrusion speeds for predetermined durations. In one embodiment, the sweeping is continuous such that the extrusion speed increases (or decreases) continuously. In one embodiment, the test pattern is a line. It will be appreciated that the extrusion in step S210 may be performed while the respective print head is above a purge bin (not depicted) of the apparatus 1000, such that the print material is deposited directly into the purge bin when extruded.

In step S220, the controller 20 receives telemetry data during the extrusion of the print material for the extrusion sweep. The apparatus 1000 may be equipped with various sensors (not shown) that measure various operational aspects such as extrusion force, nozzle temperature, idler wheel angle, etc. In particular, a correspondence is maintained between the telemetry data and the applied extrusion speed.

In step S230, the controller 20 analyzes the received telemetry data and determines the health of the extrusion sub-system based on the analysis. For example, in one embodiment, the controller 20 may analyze the measured extrusion force for one or more (or each) extrusion speed within the extrusion sweep, and compare the measured extrusion force to an acceptable range for the force value for that extrusion speed. In one embodiment, the controller 20 may evaluate any fluctuations in measured extrusion force during extrusion at a single extrusion speed (e.g., during an increment along the sweep at which extrusion is held at a particular extrusion speed for a predefined duration). In one embodiment, the controller 20 may compare the received telemetry data to prior telemetry data received during a prior performance of operation S200 and stored in memory.

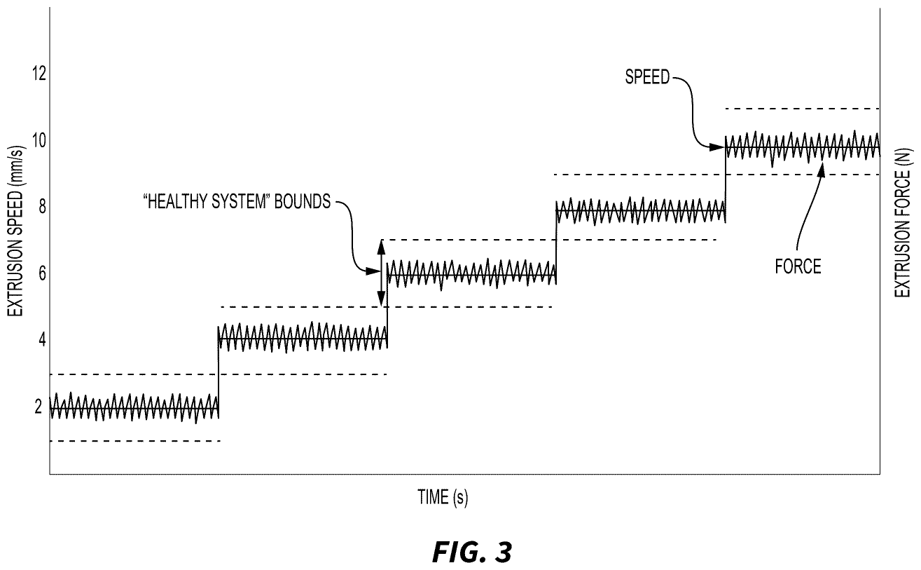

FIG. 3 illustrates one example of analysis that may be performed in step S230. The extrusion sweep depicted in this example involves an incremental increase in extrusion speed. For each extrusion speed step, lower and upper thresholds for acceptable extrusion force are defined, and the controller 20 may determine whether the measured extrusion force calls within the lower and upper thresholds for each speed step within the extrusion sweep. If the controller 20 determines that the measured extrusion force falls within the defined thresholds for all extrusion speed steps, the operation S200 may determine that the extrusion sub-system is healthy. If the controller 20 determines that a measured extrusion force falls outside of the defined thresholds for an extrusion speed step, the operation S200 may determine that the extrusion sub-system is not healthy.

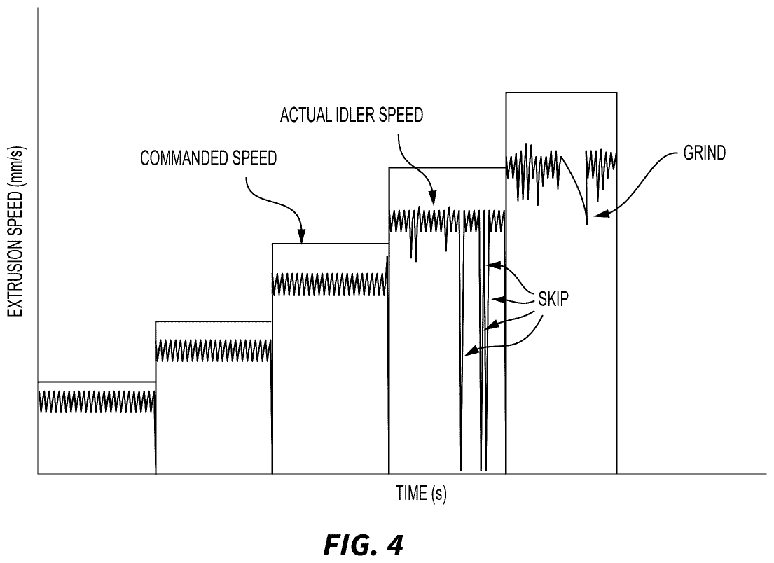

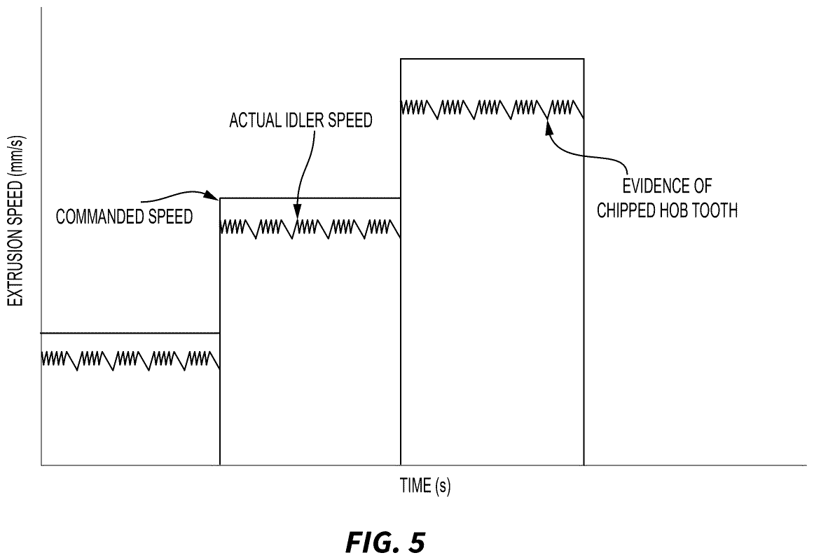

FIGS. 4 and 5 illustrate another example of analysis that may be performed in step S230. The extrusion sweep depicted in this example involves an incremental increase in extrusion speed, and the idler speed and/or angle are measured. However, the controller 20 may determine that the measurements reveal discontinuities in the idler speed/angle data, as annotated in FIGS. 4 and 5. For example, a sharp dip of large magnitude, as depicted in FIG. 4, may indicate that a skip has occurred, while a broader dip of large magnitude, as also depicted in FIG. 4, may indicate a grinding in the one of the extruder sub-system components. On the other hand, dips of small magnitude may indicate a chipped tooth in a gear in the extrusion sub-system. In one embodiment, the controller 20 determine the presence of these discontinuities by determining whether a standard deviation of the telemetry signals (e.g., for a particular extrusion speed) exceeds a threshold.

If the controller 20 determines that discontinuities are present in this data, the operation S200 may determine that the extrusion sub-system is not healthy.

In one embodiment, the controller 20 stores the received telemetry data for future access. In one embodiment, the controller 20 performs a regression on received telemetry data over time, to determine the long term behavior of the system (e.g., wear, material quality, etc.)

The concepts realized by the present invention may include, but are not limited to:
Pre-printer assessment (e.g., evaluating feedback from one or more sensors)
Printing (e.g., evaluating feedback from one or more sensors)
Data output
   Informs
   Assess
Training data
   Inform or advise
   Quality of materials
Primary Objectives
   Confirming that the extrusion system is “healthy” and ready to print (go/no go for printing)
   Confirming that the extrusion system is still healthy while printing
Secondary Objectives
   Characterizing the extrusion system (e.g., nozzle state; which nozzle is installed; bowden tube state; hob wheel state; extruder preload; extrusion force levels; feed tube health; etc.)
   Characterizing the material (e.g., actual material (onyx vs nylon white); moisture level; viscosity; etc.
   Characterizing consumable wear behavior
Tertiary Objectives
   Using above characterizations
      Recommending corrective action to a user
      Automatically taking corrective action

The above analyses will initially depend upon “models” defined by humans and will have some associated success metric. It will be appreciated that these models may be refined, or new models created based on “machine learning”, using the data generated from the above extrusion sweeps combined with additional data such as:
Human assertions that the extrusion system is healthy
Maintenance actions performed by the user (e.g., if the user replaces a bowden tube, then preceding extrusion sweeps may be indicative of a worn bowden tube)
Performance characterizations from other activities (e.g., if a print is found to be under extruding, then that may inform that the extrusion sweep might represent an under extruding extrusion system)

The above analyses may be accomplished by:
Recording the telemetry data
Recording all data associated with the printer and actions it takes
Presenting telemetry data to engineers for annotation
Training machining learning models on the above data

In another aspect of the present invention, it will be appreciated that particular apparatuses which exhibit success metrics greater than previous models may be selected for deployment to the fleet.

Other aspects of the present invention may include, but are not limited to:
Instead of extruding at fixed rates into the purge bin, actually printing a 3D part (e.g., small part, logo, or a bead)
Performing the analysis on data obtained during printing without the need for an explicit pre-print routine
Using the output of the models to determine some “compensation” (e.g., extrusion factor, using yet another model)
Calibrating the models by printing multiple parts using compensation factors that span an allowable range and seeking user input to select the best part
Adding additional sensors (e.g., camera to determine extrusion flow rate; line laser; load cell to measure preload; IR/Lidar or any other sensor that can provide information regarding the shape of an extruded bead)
Using the telemetry data to correlate sensors with one another with the aim of removing sensors in the future
Adding an internal dial indicator which measures deflection at different extrusion states.

### Other Embodiments

Incorporation by reference is hereby made to U.S. Pat. Nos. 10,076,876, 9,149,988, 9,579,851, 9,694,544, 9,370,896, 9,539,762, 9,186,846, 10,000,011, 10,464,131, 9,186,848, 9,688,028, 9,815,268, 10,800,108, 10,814,558, 10,828,698, 10,953,609, U.S. Patent Application Publication No. 2016/0107379, U.S. Patent Application Publication No. 2019/0009472, U.S. Patent Application Publication No. 2020/0114422, U.S. Patent Application Publication No. 2020/0361155, U.S. Patent Application Publication No. 2020/0371509, and U.S. Provisional Patent Application No. 63/138,987 in their entireties.

Although this invention has been described with respect to certain specific exemplary embodiments, many additional modifications and variations will be apparent to those skilled in the art in light of this disclosure. For instance, while reference has been made to an X-Y Cartesian coordinate system, it will be appreciated that the aspects of the invention may be applicable to other coordinate system types (e.g., radial). It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. An apparatus comprising:
at least one processor; and
at least one memory,
wherein the at least one memory stores computer-readable instructions which, when executed by the at least one processor, cause the processor to:
control an extrusion sub-system to extrude 3D print material;
collect sensor data during the controlled extrusion of the 3D print material by the extrusion sub-system; and
determine, based on the collected sensor data, a health of the extrusion sub-system.

2. The apparatus of claim 1, wherein the sensor data includes data relating to an extrusion force.

3. The apparatus of claim 1, wherein the controlling of the extrusion sub-system includes controlling the extrusion sub-system to extrude the 3D print material over multiple extrusion speeds.

4. The apparatus of claim 3, wherein the controlling the extrusion sub-system to extrude the 3D print material over multiple extrusion speeds includes controlling the extrusion speed of the extrusion sub-system from a first extrusion speed among the multiple extrusion speeds to a second extrusion speed among the multiple extrusion speeds in a step-wise manner.

5. The apparatus of claim 3, wherein the controlling the extrusion sub-system to extrude the 3D print material over multiple extrusion speeds includes controlling the extrusion speed of the extrusion sub-system from a first extrusion speed among the multiple extrusion speeds to a second extrusion speed among the multiple extrusion speeds in a continuous manner.

6. The apparatus of claim 1, wherein the determining of the health of the extrusion sub-system includes determining fluctuations in the collected sensor data.

7. The apparatus of claim 1, wherein the determining of the health of the extrusion sub-system includes determining whether the collected sensor data exceeds a threshold.

8. The apparatus of claim 1, wherein the determining of the health of the extrusion sub-system includes comparing sensor data collected from a current extrusion operation with sensor data collected from a previous extrusion operation.

9. The apparatus of claim 1, wherein the controlling of the extrusion sub-system includes controlling the extrusion sub-system to extrude a test pattern of the 3D print material.

10. A method comprising:
controlling an extrusion sub-system to extrude 3D print material;
collecting sensor data during the controlled extrusion of the 3D print material by the extrusion sub-system; and
determining, based on the collected sensor data, a health of the extrusion sub-system.

11. The method of claim 10, wherein the sensor data includes data relating to an extrusion force.

12. The method of claim 10, wherein the controlling of the extrusion sub-system includes controlling the extrusion sub-system to extrude the 3D print material over multiple extrusion speeds.

13. The method of claim 12, wherein the controlling the extrusion sub-system to extrude the 3D print material over multiple extrusion speeds includes controlling the extrusion speed of the extrusion sub-system from a first extrusion speed among the multiple extrusion speeds to a second extrusion speed among the multiple extrusion speeds in a step-wise manner.

14. The method of claim 12, wherein the controlling the extrusion sub-system to extrude the 3D print material over multiple extrusion speeds includes controlling the extrusion speed of the extrusion sub-system from a first extrusion speed among the multiple extrusion speeds to a second extrusion speed among the multiple extrusion speeds in a continuous manner.

15. The method of claim 10, wherein the determining of the health of the extrusion sub-system includes determining fluctuations in the collected sensor data.

16. The method of claim 10, wherein the determining of the health of the extrusion sub-system includes determining whether the collected sensor data exceeds a threshold.

17. The method of claim 10, wherein the determining of the health of the extrusion sub-system includes comparing sensor data collected from a current extrusion operation with sensor data collected from a previous extrusion operation.

18. The method of claim 10, wherein the controlling of the extrusion sub-system includes controlling the extrusion sub-system to extrude a test pattern of the 3D print material.

19. A non-transitory computer-readable medium storing a computer program which, when executed by at least one processor, causes the processor to:
control an extrusion sub-system to extrude 3D print material;
collect sensor data during the controlled extrusion of the 3D print material by the extrusion sub-system; and
determine, based on the collected sensor data, a health of the extrusion sub-system.

20. The non-transitory computer-readable medium of claim 19, wherein the controlling of the extrusion sub-system includes controlling the extrusion sub-system to extrude the 3D print material over multiple extrusion speeds.
